(19) United States
(12) Patent Application Publication
(10) Pub. No.: US 2009/0135600 A1
(43) Pub. Date: May 28, 2009

(54) OUTDOOR MENORAH

(76) Inventor: RICHARD H. BECKER, Cortlandt Manor, NY (US)

Correspondence Address: PETER D. AUFRICHTIG;MCCARTHY FINGAR LLP, 11 MARTINE AVE 12TH FLOOR, WHITE PLAINS, NY, 10606, US

(21) Appl. No.: 12/323,999

(22) Filed: Nov. 26, 2008

Related U.S. Application Data
(60) Provisional application No. 60/990,068, filed on Nov. 26, 2007.

(51) Int. Cl. F21V 21/00

(52) U.S. Cl. 362/249.14

(57) ABSTRACT

A menorah capable of being displayed outside. The menorah contains a horizontal bar having a series of light bulbs disposed therein. A vertical support bar is perpendicularly attached to the horizontal bar and supports the menorah in an upright position. A grounding stake is provided that further supports the menorah and grounds the menorah in the vent of a lightening strike.

### CROSS REFERENCE TO RELATED APPLICATIONS

This application claims the priority of provisional application Ser. No. 60/990,068 filed in the United States Patent and Trademark Office on Nov. 26, 2007.

### BACKGROUND OF THE INVENTION

The menorah plays a significant role in the Jewish Chanukah holiday (festival of Lights). Each evening, a first candle is lit (the shamash), which is then used to light the other candles in a sequential order in accordance with the number of days elapsed since the beginning of the holiday. On the second night, the shamash is lit and used to light the two rightmost candles, from left to right. On the following nights, all of the previously lit candles, as well as the next candle to the left of previously lit candles, are lit each evening, starting with the shamash and then proceeding from left to right, until the eight evenings of the holiday have elapsed. On the eighth evening, all nine positions on the menorah are occupied by burning candles.

During the Chanukah holiday there is a desire by Jewish people to display a menorah outside which will display the shamash and appropriate daily lights. Using real candles presents several disadvantages. Real candles may pose a fire hazard, particularly if left unattended or if young children are present. If the menorah is to be used outdoors, the candles most likely will be blown out by the wind.

There have been attempts to make outdoor menorahs using light bulbs, but these menorahs were typically custom one of a kind constructions made of bronze or some other weather tolerant metal material, were usually very heavy and required custom installation and electrical wiring to power the menorah. Further, many of these outdoor menorahs were hand made and not suited for commercial production. In addition, the current outdoor menorahs use full line-voltage bulbs (120 volts) which can be expensive to operate and require significant electrical service which increases the dangers of use, particularly in wet and cold conditions which are frequently found during the December holiday season.

Accordingly there is a need for an outdoor menorah, which can be effectively produced in mass production, utilizing relatively inexpensive components, with lower power requirements and easy installation and removal without the need for specialized wiring or equipment.

### SUMMARY OF THE INVENTION

The invention is generally directed to a menorah designed to be used outside.

Accordingly, it is an object of the invention to provide an improved outdoor menorah that is light weight and easy to assemble.

Another object of the invention is to provide an improved outdoor menorah that is reasonably priced and inexpensive to operate.

Yet another object of the invention is to provide an outdoor menorah that does not require custom installation.

Still yet another object of the invention is to provide an outdoor menorah suitable for mass production.

Still a further object of the invention is to provide an outside menorah which can be powered by an extension cord.

Still other objects and advantages of the invention will, in part, be obvious and will, in part, be apparent from the specification.

The invention accordingly comprises the features of construction, combinations of elements and arrangements of parts which will be exemplified in the construction as hereinafter set forth, and the scope of the invention will be indicated in the Claims.

### BRIEF DESCRIPTION OF THE DRAWINGS

For a fuller understanding of the invention, reference is made to the following description taken in connection with the accompanying drawings, in which:

FIG. 1 shows a front view of the menorah according to a preferred embodiment,

FIG. 2 is a wiring diagram showing the power of the menorah and switching, and

FIG. 3 shows a second embodiment of the invention.

### DETAILED DESCRIPTION OF THE PREFERRED EMBODIMENTS

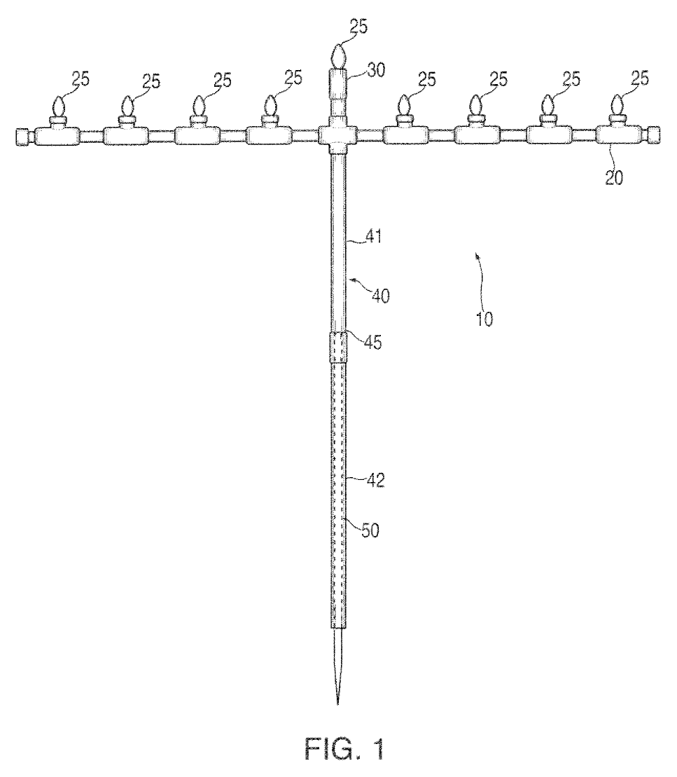

FIG. 1 shows an outdoor menorah according to the present invention. The menorah 10 contains a horizontal bar 20 for supporting a series of light bulbs 25 connected to a vertical bar 40. In the case of a menorah nine light bulbs are needed. These bulbs are used to indicate each night of Chanukah. The center (ninth) light, the shamash 30, is centered exactly in the middle of the horizontal bar 20. There are four bulbs evenly placed to either side of the shamash. In a preferred embodiment, the shamash is raised higher than the surrounding eight lights, preferably five inches. The horizontal bar 20 can also be in various other shapes such as a concave shape creating a bowed effect. In addition, the lights can be in a single line or the center shamas can be elevated above the other lights.

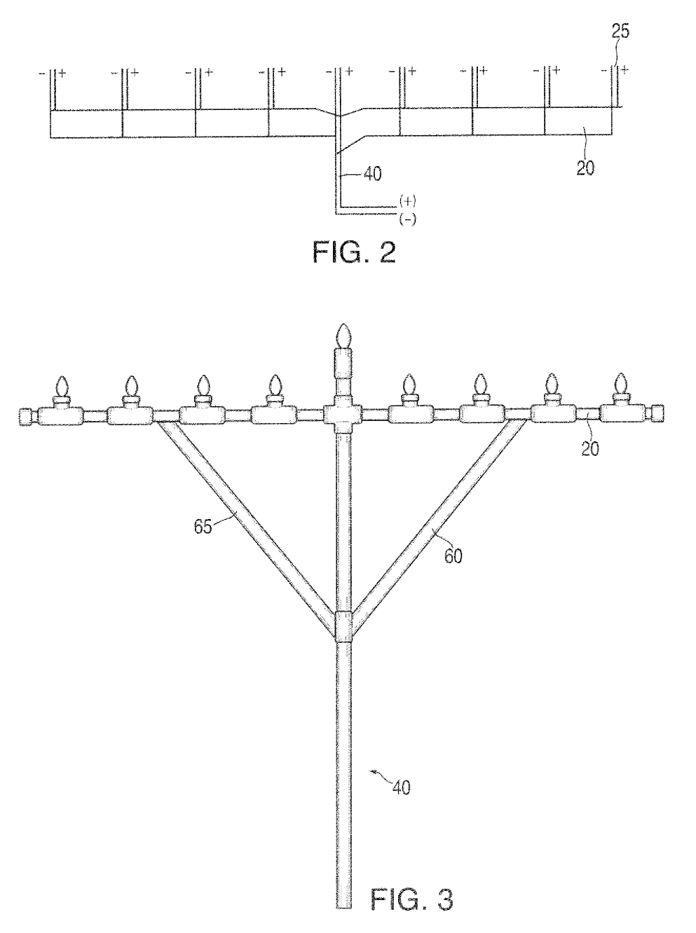

The bulbs 25, sockets and wiring are all water tight and will be UL listed for outdoor use. In another embodiment, the menorah could be for indoor use and not have the requirement for the strict UL safeguards. The bulbs 25 used are low wattage, preferably c-9, 7-watt (Christmas style) bulbs. The bulbs 25 can also be screw in lamp style bulbs, candle style bulbs or LED lights. The lights can either be fixed or flickering. As show in FIG. 2, the bulbs 25 are wired in a parallel manner so the bulbs 25 can be individually lit or lit all at once. The unit will be controlled via an optional timer, to allow the Menorah to remain lit from dusk to dawn, or at other preferred times. These timers provide manual override, to allow the menorah to be turned on and off at will. There will be two models available to control the individual bulbs. The basic model will allow the bulbs to be lit by simply tightening them in their individual sockets. The wiring of the menorah consists of line voltage (120 volt) capacity copper wiring, with the bulbs wired in a typical “Christmas-style” parallel fashion as shown in FIG. 2, allowing all bulbs to remain lit, should one bulb burn out or otherwise fail.

Bulbs not in use will remain dark by allowing them to sit loosely in their sockets. The higher end units will have individual switches for each bulb, located on the short vertical segments, below the bulb, but above the horizontal bar. These switches will be UL rated for outdoor use. The horizontal bar is hollow such that the wires connecting to the lights are secured and protected within the bar and not visible from the outside.

As seen in FIG. 1, the horizontal bar is supported by a vertical bar 40. The vertical support bar 40 is perpendicularly attached to the horizontal bar 20. The vertical bar can come in disassembled pieces 41, 42, preferably 2 or 3, for easier packing and storing. Each piece would have a tapered end 45 to fit inside the next piece for assembly. This type of fitting allow for ease of connection as well as stability of the menorah. The vertical bar 40 is hollow and is slid over a metal pole or stake 50 that is driven approximately twelve inches into the ground. This stake 50 acts both as a support and as an electrical grounding device for the menorah and is preferably thirty inches in length. Depending on the display needs, the heights of the vertical bar can be either available in different lengths or adjustable. The stake also helps support the menorah so that it does not fall over, even when it is windy. FIG. 3 shows a second embodiment of the menorah where angled support bars 60, 65 are added between the vertical support bar 40 and the horizontal bar 20.

The horizontal 20 and vertical 40 bars are made of a light weight material, preferably a 1½ outside diameter plastic or polyvinyl chloride (PVC) tube with the ends sealed by appropriate caps. The menorah can be modular such that it can be assembled and disassembled for easier shipping and storage. The entire Menorah is modular in design and construction. It is made of 1½ inch O.D. PVC tubing, with tapered ends, allowing the pieces to be quickly assembled, both at the factory, as well as by the end user. These modular units consist of a single vertical assembly, and a horizontal bar comprised of multiple and identical sections of PVC tubing, which serve as spacers. The horizontal bar also contains 9 modular PVC bulb supports, 8 of which are identical in length, and a ninth that is approx 3-6 inches longer than the other 8 (for the shamash).

The electric power cord exits the vertical bar near its base so that its connection to the power supply (either an outdoor outlet or an outdoor extension cord) is relatively inconspicuous. The power cord extends up the vertical bar and extends through the horizontal bar and is attached to each light bulb.

The menorah can range in size and is preferably from about 4 feet to 12 feet in width and from 4 to 10 feet in height, though it can be smaller or larger than the changing on the anticipated display needs. In addition, various types of light bulbs can be utilized, such as ornamental bulbs, various colored bulbs and various styles can be used such as flames, candelabras etc.

It will thus be seen that the objects set forth above, among those made apparent in the preceding description, are efficiently obtained and, since certain changes may be made in the above constructions without departing from the spirit and scope of the invention, it is intended that all matter contained in the above description or shown in the accompanying drawings shall be interpreted as illustrative, and not in a limiting sense.

It is also to be understood that the following claims are intended to cover all of the generic and specific features of the invention, herein described and all statements of the scope of the invention which, as a matter of language, might he said to fall there between.

What is claimed is:

1. A menorah capable of being displayed outside comprising;
A vertical bar for supporting the menorah;
A horizontal bar attached perpendicularly to the vertical bar;
A series of lights disposed along the horizontal bar;
Electrical wiring for supplying power to the lights; and
A grounding support element.
